(19) United States
(12) Patent Application Publication
(10) Pub. No.: US 2002/0166968 A1
(43) Pub. Date: Nov. 14, 2002

(54) Apparatus and method of measuring bolometric resistance changes in an uncooled and thermally unstabilized focal plane array over a wide temperature range

(76) Inventor: Martin G. Bradley, Irvine, CA (US)

Correspondence Address: Daniel L. Dawes, MYERS, DAWES & ANDRAS LLP, 19900 MacArthur Boulevard, Suite 1150, Irvine, CA, 92612, US

(21) Appl. No.: 09/853,245

(22) Filed: May 11, 2001

(51) Int. Cl. G01J 5/00

(52) U.S. Cl. 250/338.1; 250/332

(57) ABSTRACT

A signal is sensed from a bolometer element in an uncooled and thermally nonstabilized focal plane array with a Wheatstone bridge over any temperature range across which there is thermal variation which in practice is any range of more than 1° C. and then corrected for spatial nonuniformity. Temperature compensation parameters are provided from a calibration database as a function of ambient temperature by using a flash random access memory. An array of gain and offset values are provided in the memory for each pixel in the focal plane array for each potential operating temperature over the entire temperature range. The temperature compensation uses analog processing and a reference temperature measurement from the focal plane array as an index marker to directly access an appropriate bank of the flash memory that contains the appropriate gain and offset settings that can either be read directly into the focal plane array via its read-out integrated circuit or using analog circuits.

### BACKGROUND OF THE INVENTION

1. Field of the Invention

The invention relates to infrared instruments and cameras and in particular to compensation circuitry for the same.

2. Description of the Prior Art

Recent advances in infrared (IR) detector technology have led to the commercially availability of new detector technologies that do not require cryogenic cooling. These new detector technologies include ferroelectric and micro-bolometer technologies. The currently commercially available microbolometer detector arrays are based on a technology that was originally developed by Honeywell Sensor & System Development Center and was licensed to Boeing (formerly Rockwell), Raytheon (formerly Hughes' Santa Barbara Research Center) and Lockheed-Martin (formerly Loral).

While these new technologies do not require cryogenic cooling, they are traditionally operated with a thermoelectric cooler to maintain a constant focal plane temperature usually between 0° to 25° C. The purpose of maintaining a constant detector temperature is that this will simplify the interpretation of the signal generated by the detector array and the generation of a thermal image. Since the detector is at a constant temperature, any measured voltage changes must correspond to thermal differences in the scene that is being imaged onto the focal plane array (focal plane array). The resulting simplification in processing is a result of assuming that the measured temperature differences and the temperature of focal plane array are constant. The apparent temperature of an object in the scene as compared to the average temperature of the scene at the focal plane array is small as compared to the average temperature of the scene (ΔT<<T). Assuming the temperature of the focal plane array is constant, then it can be assumed that the measured changes in voltage, that are the result of resistivity changes, are considered to be approximately linear as related to temperature. Since the transform is based on a linear relationship, then the slight differences in the responsivity of the individual elements in the array are typically corrected using a two point calibration that determines an offset and gain correction for each pixel. The results of this two point calibration are independent of the ambient temperature. See for example Parrish , et al., “Methods And Circuitry For Correcting Temperature-Induced Errors In Microbolometer Focal Plane Array, ” U.S. Pat. No. 5,756,999 (1998) which is incorporated herein by reference.

Thus, while there is a potential of using an uncooled microbolometer focal plane array without a thermoelectric cooler, the difficulty is that calculating the conversion between the measured voltage to a perceived scene temperature difference is now a more complex calculation. The relationship between the voltage and the temperature varies with the temperature of the focal plane array, and the specifics of this variation are different for every pixel in the array. Since the focal plane array temperature is unregulated, just viewing an IR scene will result in heating of the focal plane array.

In addition in an uncooled and thermally nonstabilized array the resistivity swings of the bolometric elements may be so large that the chip electronics is driven to the rail voltages and currents so that calibration and data collection becomes impossible.

Therefore, some means must be found where the temperature dependence of the focal plane array can be monitored and then used for compensation.

### BRIEF SUMMARY OF THE INVENTION

The invention is a method comprising the steps of sensing a signal from a bolometer element in an uncooled and thermally nonstabilized focal plane array with a bridge over a temperature range in which there is a thermal variation, which in practice is any range over 1° C., and correcting the signal for spatial nonuniformity across that temperature range. In the illustrated embodiment the focal plane array has a temperature range which is compensated over a 100° C. range.

The step of sensing the signal is preferably performed with a Wheatstone bridge. The step of correcting the signal for spatial nonuniformity comprises correcting the signal at a plurality of temperature increments spanning the temperature range, namely by providing temperature compensation parameters from a calibration database as a function of ambient temperature without the use of intensive digital numeric processing. This is preferably accomplished by using a flash random access memory as a memory storage medium for the calibration database. The database is accessed or addressed based the temperature measurements. The calibration database provides in the illustrated embodiment an array of gain and offset values for each pixel in the focal plane array for each potential operating temperature over the entire temperature range. The temperature compensation or correction uses limited analog processing and a reference temperature measurement from the focal plane array as an index marker to directly access an appropriate bank of the flash memory that contains the appropriate gain and offset settings that can either be read directly into the focal plane array via its read-out integrated circuit or using analog circuits.

The invention also includes an apparatus for performing the above methodology.

While the method has been described for the sake of grammatical fluidity as steps, it is to be expressly understood that the claims are not to be construed as limited in any way by the construction of “means” or “steps” limitations under 35 USC 112 , but to be accorded the full scope of the meaning and equivalents of the definition provided by the claims. The invention can be better visualized by turning now to the following drawings wherein like elements are referenced by like numerals.

### BRIEF DESCRIPTION OF THE DRAWINGS

FIG. 1 is a perspective view of a focal plane array in which bridges of the invention have been incorporated.

FIG. 2 is a schematic of a Wheatstone bridge used in connection with each pixel detector in the focal plane array of FIG. 1.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

During the 1880's, an infrared detector called the bolometer was developed. The bolometer operates on the principle that the electrical resistance of the bolometer material changes with respect to the bolometer temperature, which in turn changes in response to the quantity of absorbed incident infrared radiation. These characteristics can be exploited to measure incident infrared radiation on the bolometer by sensing the resulting change in its resistance. When used as an infrared detector, the bolometer is generally thermally isolated from its supporting substrate or surroundings to allow the absorbed incident infrared radiation to generate a temperature change in the bolometer material.

Modern microbolometer structures were developed by the Honeywell Corporation. For a recent summary of references see U.S. Pat. No. 5,420,419. Microbolometer arrays are typically fabricated on monolithic silicon substrates or integrated circuits by constructing two-dimensional arrays of closely spaced air bridge structures coated with a temperature sensitive resistive material, such as vanadium oxide, that absorbs infrared radiation. The air bridge structure provides good thermal isolation between the microbolometer detector and the silicon substrate. A typical microbolometer structure measures approximately 50 microns by 50 microns.

Microbolometer arrays can be used to sense a focal plane of incident radiation (typically infrared) by absorbing the radiation and producing a corresponding change in the temperatures and therefore resistances of each microbolometer in the array. With each microbolometer functioning as a pixel, a two-dimensional image or picture representation of the incident infrared radiation can be generated by translating the changes in resistance of each microbolometer into a time-multiplexed electrical signal that can be displayed on a monitor or stored in a computer. The circuitry used to perform this translation is commonly known as the Read Out Integrated Circuit (ROIC), and is fabricated as an integrated circuit in the silicon substrate. The microbolometer array is then fabricated on top of the ROIC. The combination of the ROIC and microbolometer array is commonly known as a microbolometer infrared Focal Plane Array (FPA). Microbolometer FPAs containing as many as 320×240 detectors have been demonstrated.

Individual microbolometer detectors will have non-uniform responses to uniform incident infrared radiation, even when the bolometers are manufactured as part of a microbolometer FPA. This is due to small variations in the detectors' electrical and thermal properties as a result of the manufacturing process. These non-uniformities in the microbolometer response characteristics must be corrected to produce an electrical signal with adequate signal-to-noise ratio for image display or processing.

Under the conditions where uniform electrical bias and incident infrared radiation are applied to an array of microbolometer detectors, differences in detector response will occur. This is commonly referred to as spatial non-uniformity, and is due to the variations in a number of critical performance characteristics of the microbolometer detectors. This is a natural result of the microbolometer fabrication process. The characteristics contributing to spatial non-uniformity include the infrared radiation absorption coefficient, resistance, temperature coefficient of resistance (TCR), heat capacity, and thermal conductivity of the individual detectors. This spatial nonuniformity is corrected using the methodology disclosed in application serial no ______ , filed on ______ , entitled, “A Method And Apparatus For Temperature Compensating An Uncooled Focal Plane Array” and assigned to the same assignee as the present invention, which application is incorporated herein by reference. However, the use of a Wheatstone bridge for wide temperature variations in an uncooled and unstabilized focal plane array is both novel and allows the above methodology to be practically implemented with circuitry having conventional input and output ranges, and reduces the size of the calibration database needed to compensate the temperature variations normally found in the spatial nonuniformities of bolometer arrays.

The above method provides gain, offset and/or bias correction tables as a function of ambient temperature without the use of intensive digital numeric processing and to an apparatus for performing the same. The method corrects for the temperature induced non-uniform response of a array of detectors 12 in a focal plane array 10 without the use of digital processing and/or computations. Although the bridge 14 of the invention may be used with other methodologies, the use of the bridge 14 of the invention synergistically enables the methodology to be practiced in circuitry with conventional performance parameters.

The method contemplates an electronic implementation using high density flash random access memory, RAM, as the memory storage medium for the calibration database, accessing this database based digitized temperature measurements, and then using the bias, gain and offset data within the database to correct for focal plane array response variation induced by temperature changes. The calibration database is comprised of an array of bias, gain and offset values for each pixel in the sensor for each potential operating temperature over the entire range of potential operating temperatures.

One of the innovations incorporated into the methodology is based on using limited analog processing and the digitized response of reference temperature measurements from the focal plane array, as an index marker that can be used to directly access the appropriate bank of flash memory that contains the appropriate gain, offset, and bias settings that can either be read directly into the focal plane array via its read-out integrated circuit or can be performed using simple analog circuits.

One benefit of the method used in combination with bridge 14 is that imagery generated from an focal plane array 10, whose response varies non-uniformly with temperature will be consistent even as the ambient temperature varies. The illustrated embodiment explicitly contemplates a long wave infrared (LWIR) microbolometer focal plane array 10 typically operating in the range of 8-14 μm and a short wave infrared (SWIR) InGaAs focal plane array 10 typically operating in the range of 0.7-1.5 μm such as Sensors Unlimited, Inc.'s model number SU320-1.7T1. However, any focal plane array 10 now known or later devised may benefit from application of the present invention. This approach for compensating for ambient temperature variation will significantly reduce the power as compared to the traditional approach based on using a thermoelectric cooler to regulate the temperature of the focal plane array 10.

The methodology is based on using flash memory to retain all potential bias, gain and offset values. This memory is accessed via digitization of a temperature measurement with no digital processing required. As a result the size, power consumption and production cost of the camera is significantly reduced. The gain, offset and/or bias for each pixel of the focal plane array is determined at each small temperature increment over the entire operating temperature range. The size of this small temperature increment is based on temperature measurement accuracy and the minimum temperature increment that results in a significant change in the focal plane array's response.

The resulting flash memory database can then be accessed by: measuring the ambient temperature on the focal plane array; digitizing this temperature measurement using an analog to digital converter (ADC); applying a fixed offset and gain value to this digitized temperature reading that results in calculating the flash memory address; and the address is then used as a pointer to the portion of memory that should be read out, where the portion of memory that is read out is the data for the measured ambient temperature of the focal plane array.

In an uncorrected array 10 the magnitude of the response non-uniformity can be substantially larger than the magnitude of the actual response due to the incident infrared radiation. The resulting ROIC output signal is difficult to process, as it requires system interface electronics having a very high dynamic range. In order to achieve an output signal dominated by the level of incident infrared radiation, processing to correct for detector non-uniformity is required.

Previous methods for implementing an ROIC for microbolometer arrays have used an architecture wherein the resistance of each microbolometer is sensed by applying a uniform voltage and current and a resistive load to the microbolometer element. The current resulting from the applied voltage is integrated over time by an amplifier to produce an output voltage level proportional to the value of the integrated current. The output voltage is then multiplexed to the signal acquisition system.

Gain and offset corrections are applied to the output signal to correct for the errors which arise from the microbolometer property non-uniformities. This process is commonly referred to as two-point correction. In this technique two correction coefficients are applied to the sampled signal of each element. The gain correction is implemented by multiplying the output voltage by a unique gain coefficient. The offset correction is implemented by an adding a unique offset coefficient to the output voltage. Both analog and digital techniques have been utilized to perform two-point non-uniformity correction.

The current state-of-the-art in microbolometer array ROICs suffers from two principal problems. The first problem is that the large magnitude of the microbolometer introduced non-uniformities in the ROIC output signal requires a large instantaneous dynamic range in the sensor interface electronics, increasing the cost and complexity for the system. Current advanced ROIC architectures incorporate part of the correction on the ROIC to minimize the instantaneous dynamic range requirements at the acquisition systems interface.

The second problem is that the application of a fixed coefficient two-point gain and offset correction method to minimize array non-uniformity works well only for a very small range of substrate temperatures, on the order of 0.005 to 0.025 degrees Kelvin. In order to maintain the substrate temperature within this range, a thermoelectric cooler, temperature sensor, and temperature control electronics are required, again adding to system cost and complexity.

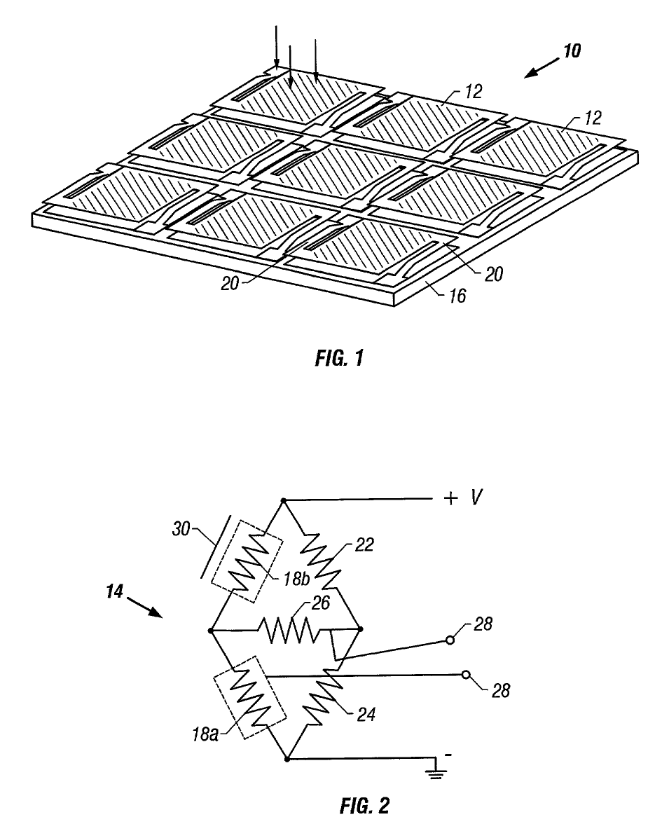

As shown in FIG. 1 focal plane array 10 is comprised of a plurality of photo-resistive detectors 12 based on micro-machined mechanical Wheatstone bridge structures 14 shown in FIG. 2 that are integrally fabricated with the array 10 on a silicon (Si) substrate 16. The detector 12 is composed of silicon nitride with a thin layer (approximately 0.5 micron) of vanadium oxide (VOₓ) for the temperature sensitive resistors 18a and b shown in FIG. 2. VOₓis used since it has a high temperature coefficient of resistance (approximately −2.5%/° C.) and its relatively low sheet resistance. Detector 12 is suspended above the readout integrated circuit formed in substrate 16 by two thin legs 20 that assist in isolating detector 12 thermally for the substrate 16 of the readout integrated circuit by means of the interlying air gap.

FIG. 2 is a schematic of a Wheatsone bridge 14 in which VOₓ resistors 18a and 18b are thermally isolated by being formed in detector 12 cantilevered above substrate 16 by legs 20. The dotted outline box around resistors 18a and 18b symbolizes their thermal isolation. In addition, resistor 18b is IR shielded as symbolically denoted by shield 30. Resistors 22, 24 and 26 forming the other legs of bridge 14 and the center element are conventional resistors formed in substrate 16 and are characterized as having a low thermal coefficient of resistance. Furthermore, resistors 22, 24 and 26 are heat sinked to substrate 16 by virtue of their fabrication in substrate 16. Output 28, which is the voltage across center resistor 26, is provided to the read out circuit as the pixel output.

Incident IR radiation is absorbed by the silicon nitride plate of detector 12 and causes it to change temperature. This temperature change results in changing the electrical resistance of the thin film VOₓ resistors exposed to the incident IR radiation. As described below in connection with FIG. 2 each detector 12 includes a thermally isolated bolometric resistor 18a which is exposed to IR radiation and a thermally isolated shielded bolometric resistor 18b which is not exposed to IR radiation. Both resistors 18a and 18b also have a small current flowing through them in the bridge 14 of FIG. 2 which causes ohmic heating of both. In addition there may a small temperature drift of detector 12 due to general heating the entire isolated surface from IR radiation and from thermal conduction through legs 20 from substrate 16. However, during short intervals of time characteristic of measurement periods, there is a small difference in the resistance of resistor 18a over that of resistor 18b due to the differential IR heating of the exposed resistor 18a. Bridge 14 cancels out identical resistance changes which occur to both resistors 18a and 18b, leaving as a useful signal the differential resistance change between the two which is due to the differential IR heating of the exposed resistor 18a. This resistance change is then sensed by the electronic circuitry in readout integrated circuit. The temperature of each detector 21 or pixel in the image is thus measured.

Bridge 14 thus minimizes the errors in resistance measurement due to self-heating or ohmic heating. The output 28 will remain relatively constant in spite of a change in ambient temperature, because the increase in resistance of the resistor 18a and shielded resistor 18b will increase by approximately the same amount and keep the voltage drops across the resistors 22, 24 and 26 of the bridge 14 approximately unchanged. What was previously not known was that a bridge 14 could be used over a wide temperature range in uncooled, unstabilized bolometers, since previously no practical means was known to compensate for spatial nonuniformity among detectors 12 over a wide temperature range.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

We claim:

1. A method comprising:
sensing a signal from a bolometer element in an uncooled and thermally nonstabilized focal plane array with a bridge over a temperature range; and
correcting said signal for spatial nonuniformity.

2. The method of claim 1 where sensing said signal is performed with a Wheatstone bridge.

3. The method of claim 1 where correcting said signal for spatial nonuniformity comprises correcting said signal at a plurality of temperature increments spanning said temperature range.

4. The method of claim 1 where correcting said signal for spatial nonuniformity comprises providing a calibration database as a function of ambient temperature without the use of intensive digital numeric processing by using a flash random access memory as a memory storage medium for said calibration database, measuring said ambient temperature; accessing said database based said temperature measurements, and using said database to correct for said spatial nonuniformity of said focal plane array.

5. The method of claim 4 where providing a calibration database provides said calibration database with an array of gain and offset values for each pixel in said focal plane array for each potential operating temperature over said entire temperature range.

6. The method of claim 5 correcting said signal uses limited analog processing and a reference temperature measurement from said focal plane array, as an index marker used to directly access an appropriate bank of said flash memory that contains the appropriate gain and offset settings that can either be read directly into said focal plane array via its read-out integrated circuit or using analog circuits.

7. An apparatus comprising:
an uncooled and thermally nonstabilized focal plane array having a plurality of bolometer elements;
means for sensing a signal from each one of said plurality of bolometer elements in said uncooled and thermally nonstabilized focal plane array over a temperature range by use of a corresponding plurality of bridges; and
means for correcting said signal for spatial nonuniformity.

8. The apparatus of claim 7 where said means for sensing said signal comprises a Wheatstone bridge.

9. The apparatus of claim 7 where said means for correcting said signal for spatial nonuniformity comprises means for correcting said signal at a plurality of temperature increments spanning said temperature range.

10. The apparatus of claim 7 where said means for correcting said signal for spatial nonuniformity comprises means for providing a calibration database as a function of ambient temperature without the use of intensive digital numeric processing by use of a flash random access memory, and where said database is accessed based on ambient temperature measurement.

11. The apparatus of claim 4 where said means for providing a calibration database provides said calibration database with an array of gain and offset values for each pixel in said focal plane array for each potential operating temperature over said entire temperature range.

12. The apparatus of claim 11 further comprising a read-out circuit coupled to said focal plane array, where said flash memory includes addressable banks of memory, and where said means for correcting said signal uses limited analog processing and a reference temperature measurement from said focal plane array as an index marker used to directly access an appropriate one of said banks of said flash memory that contains the appropriate gain and offset settings that is read directly into said focal plane array via said read-out integrated circuit.

13. The apparatus of claim 11 further comprising an analog circuit coupled to said focal plane array, where said flash memory includes addressable banks of memory, and where said means for correcting said signal uses limited analog processing and a reference temperature measurement from said focal plane array as an index marker used to directly access an appropriate one of said banks of said flash memory that contains the appropriate gain and offset settings that is read directly into said focal plane array via said analog circuit.

14. An apparatus comprising:
an uncooled and thermally nonstabilized focal plane array having a plurality of detectors;
a plurality of Wheatstone bridges included in said focal plane array for sensing a signal from said detectors in said uncooled and thermally nonstabilized focal plane array over a temperature range; and
a temperature compensation circuit including a calibration database using a flash random access memory, and where said database is accessed based on ambient temperature measurement to provide a plurality of gain and offset values for each detector in said focal plane array for each potential operating temperature over said entire temperature range.

15. The apparatus of claim 14 further comprising a read-out circuit coupled to said focal plane array, where said flash memory includes addressable banks of memory, and where said temperature compensation circuit uses limited analog processing and a reference temperature measurement from said focal plane array as an index marker used to directly access an appropriate one of said banks of said flash memory that contains the appropriate gain and offset settings that is read directly into said focal plane array via said read-out integrated circuit.

16. The apparatus of claim 14 further comprising an analog circuit coupled to said focal plane array, where said flash memory includes addressable banks of memory, and where said temperature compensation circuit uses limited analog processing and a reference temperature measurement from said focal plane array as an index marker used to directly access an appropriate one of said banks of said flash memory that contains the appropriate gain and offset settings that is read directly into said focal plane array via said analog circuit.
